(19) United States
(12) Patent Application Publication
(10) Pub. No.: US 2026/0039971 A1
(43) Pub. Date: Feb. 5, 2026

(54) CHARACTERISATION OF RESIDENT SPACE OBJECTS USING EVENT-BASED SENSORS

(71) Applicant: WESTERN SYDNEY UNIVERSITY, Penrith, New South Wales (AU)

(72) Inventors: Andrew JOLLEY, Penrith (AU); Gregory COHEN, Penrith (AU); André VAN SCHAIK, Penrith (AU)

(21) Appl. No.: 18/996,815

(22) PCT Filed: Jul. 19, 2022
(86) PCT No.: PCT/AU2022/050770

§ 371 Date: Jan. 17, 2025

(51) Int. Cl. H04N 25/47; H04N 7/18; H04N 23/61; H04N 23/695; H04N 23/71

(52) U.S. Cl. CPC H04N 25/47; H04N 7/181; H04N 23/61; H04N 23/695; H04N 23/71

(57) ABSTRACT

Disclosed herein is a method for remote monitoring, comprising determining, from event signals obtained from an event-based vision sensor, a rate of those event signals generated in response to changes associated with a specific object and, optionally, determining a brightness of the specific object from exposure measurements associated with the event signals.

### TECHNICAL FIELD

The disclosure herein relates to a method and system for monitoring a remote region using an event-based vision sensor, and to a product produced using such a method or system. The method, system and product have particular application in facilitating characterisation of a resident space object (RSO).

### BACKGROUND

RSOs are monitored for space domain awareness (SDA). Frame-based vision sensors are conventionally used for this task.

Frame-based sensors are integrating sensors, for which the generated photocurrent of each pixel is integrated over the exposure time of the frame. The exposure time is a controllable parameter of the camera, and is typically proportional to the light level of the image. Faint objects can be made visible by long exposure times, as long as the object is held still in the field of view. Hence, to compensate for the earth's rotation, traditional optical SDA approaches move the telescope mount to keep the stars still in the field of view, typically using a robotic system to precisely adjust the field of view of the sensor. Alternatively, to observe faint objects such as satellites or asteroids, the target object can be held still in the field of view of the sensor, as long as a sufficiently precise estimate of the target object's trajectory is available.

Frame-based vision sensors are used to characterise RSOs by measuring the RSO's brightness, sometimes in different colour wavebands, and monitoring how the brightness changes over various timescales. Characteristics of those measurements, such as brightness magnitude, brightness oscillation frequency, or colour ratio, can allow the calculation of RSO rotation rates, help to distinguish between different RSOs, or determine whether or not an RSO is stabilised or tumbling. Spectroscopic measurements can also sometimes indicate the presence of certain material types. These types of data are important for various reasons, including: to maintain track of known RSOs, which in turn aids in preventing on-orbit collisions; determining the health status of satellites; more accurately propagating RSO orbits to assess collision probability; aiding in the active removal of defunct satellites; and assessing satellite capabilities. However, obtaining such information using frame-based sensors remains a considerable challenge due to: the need for finite exposure times; insufficient temporal resolution; and pixel saturation during bright reflections.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the words “comprise” and “include”, and variations such as “comprises”, “comprising”, “includes” and “including”, will be understood to imply the inclusion of a stated element, integer or step, or group of elements, integers or steps, but not the exclusion of any other element, integer or step, or group of elements, integers or steps.

### SUMMARY

A first aspect of the disclosure herein relates to a method for remote monitoring, comprising:
determining, from event signals obtained from an event-based vision sensor, a rate of those event signals generated in response to changes associated with a specific object and, optionally, determining a brightness of the specific object from exposure measurements associated with the event signals.

The specific object may be located in a region remote from the sensor. The sensor may be configured to generate event signals, and optionally associated brightness measurements, in response to changes it senses in the remote region. The sensor may be located on Earth or on a RSO. In some embodiments, the sensor is located on Earth and the remote region is in space. In other embodiments, the sensor is located in space, such as on a RSO, and the remote region is located on Earth. The specific object may, for example, be a RSO, a drone, a missile, an animal, or a structure.

Variations in the rate, and optionally the brightness, over time may be logged. Variations in the rate over time may be logged relative to GPS time. The method may comprise inferring or determining information about the specific object based on variations in the rate and/or brightness over time. The inferring or determining information based on variations in the rate and/or brightness over time may comprise identifying repeating patterns in the rate and/or brightness over time and determining a rotational speed of the specific object about one or more axes based on a frequency at which those patterns repeat. The method may comprise calculating the temporal length of a spike in the rate and/or brightness to determine an angular width of a specular reflection that caused that spike.

The method may comprise determining, from event signals obtained contemporaneously from two event-based vision sensors, each of the event-based vision sensors having a different colour filter, a rate of those event signals generated in response to changes associated with a specific object and, optionally, determining a brightness of the specific object from exposure measurements associated with the event signals. The method may comprise determining material characteristics of the specific object based on differences in the event rate data and/or brightness data from each of the sensors.

The method may comprise associating a said event signal with a specific object based on:
(i) the event signal being generated in response to a said change occurring within a first predetermined distance from a centre of the specific object, wherein the centre of the specific object may be a known location or a predicted location; and/or
(ii) the event signal being generated in response to a said change occurring: (a) along a trajectory of the specific object; and/or (b) in close proximity to a most recent earlier said event signal associated with the specific object; and/or
(iii) whether the event signals occur within a subframe of a pixel array of the sensor that is visually determined to contain the specific object.

The associated said change occurring in close proximity to the most recent earlier said event signal may comprise: the associated said change occurring within a first predetermined time interval; and/or the associated said change occurring within a second predetermined distance from the centre of the specific object, wherein the second predetermined distance may be the same as or different to the first predetermined distance. The first predetermined distance may be measured in pixels. The first predetermined distance may be based on a number of pixels of the event-based vision sensor occupied by the specific object. The method may comprise updating the centre and/or velocity of the specific object based on subsequent said event signals that are associated with the specific object. The method may comprise periodically re-determining the centre of the specific object based on subsequent said event signals that are associated with the specific object and calculating a velocity of the specific object across a pixel array from changes in the location of the centre over time. The centre of the specific object may be re-determined approximately every 10 milliseconds.

The method may comprise flagging multiple event signals that are generated in response to associated said changes occurring: (i) along a linear path; and (ii) in close proximity to one another, and associating those multiple event signals with a specific object. The associated said changes occurring in close proximity to one another may comprise the associated said changes occurring within a first predetermined time interval of one another. The first predetermined time interval may be in the order of one millisecond. The method may further comprise determining a centre and/or velocity of the specific object from one or more of the multiple event signals. The method may comprise associating a subsequent said event signal with the specific object based on:
(i) the subsequent event signal being generated in response to a said change occurring within a predetermined distance from the centre of the specific object; and/or
(ii) the subsequent event signal being generated in response to an associated said change occurring: (a) along the linear path; and/or (b) in close proximity to the most recent of the multiple event signals.

The associated said change occurring in close proximity to the most recent of the multiple event signals may comprise: the associated said change occurring within a second predetermined time interval, which may be the same as or different to the first predetermined time interval; or the associated said change occurring within a first predetermined distance from the centre of the specific object. The first predetermined distance may be measured in pixels. The first predetermined distance may be based on a number of pixels of the event-based vision sensor occupied by the specific object. The method may comprise updating the centre and/or velocity of the specific object based on subsequent said event signals that are associated with the specific object. The method may comprise periodically re-determining the centre of the specific object based on subsequent said event signals that are associated with the specific object and calculating a velocity of the specific object across a pixel array from changes in the location of the centre over time. The centre of the specific object may be re-determined approximately every 10 milliseconds.

Determining the rate of those event signals generated in response to changes associated with a specific object may comprise:
determining, for each pixel associated with those event signals, the time interval between each of those event signals associated with that pixel;
determining a moving mean of those time intervals for a predetermined number of event signals;
determining the rate at the time of each of those event signals to be the inverse of the moving mean at that time.

For example, if the specific object occupies two pixels (A and B), and pixel A generates a first event signal at a first point in time and a second event signal 100 milliseconds later, and pixel B generates a first event signal at a first point in time and a second event signal 100 milliseconds later, with the event signals of pixel A and pixel B being offset from one another temporally by one millisecond, then two time intervals, each of 100 milliseconds are determined (not two time intervals of one millisecond and two time intervals of 99 milliseconds). The predetermined number of events may be approximately one tenth of the number of those event signals generated per second.

Determining the brightness of the specific object from the exposure measurements may comprise summing all associated said exposure measurements within a predetermined distance from the centre of the specific object. This predetermined distance may be the same as the first predetermined distance.

In alternative embodiments, determining the rate of those event signals generated in response to changes associated with a specific object may comprise determining the number of those event signals generated in sequential time intervals each of a predetermined duration. The predetermined duration may be approximately one tenth of a second.

An orientation of the sensor may be adjusted based on the trajectory of a said specific object. Location information associated with said event signals may be adjusted to account for changes in the orientation of the sensor.

The sensor may be mounted to an optical telescope.

### BRIEF DESCRIPTION OF DRAWINGS

A method embodying principles disclosed herein will now be described, by way of example only, with reference to the accompanying Figures, in which:

FIG. 1 is a plot of event rate data for Low Earth Orbit (LEO) satellite Globalstar 06, the event rate data obtained using an embodiment of the method disclosed herein;

FIG. 2 depicts a plot of event rate data for a RSO in the form of a rocket body (image inset), the event rate data obtained using an embodiment of the method disclosed herein;

FIGS. 3 and 4 depict a plot of colour event-rate data and associated event-rate ratios for LEO satellite Globalstar 22, the event rate data obtained using an embodiment of the method disclosed herein; and

FIG. 5 shows an artist's impression of the LEO satellite Globalstar 22

### DESCRIPTION OF EMBODIMENTS

The applicant has developed the use of neuromorphic event-based vision sensors for monitoring RSOs for space domain awareness (SDA). Event-based vision sensors have several advantages over frame-based imagers that are conventionally used for this task, including the following: they have higher temporal resolution; can image better while the field of view is moving; have a significantly lower data rate for sparse scenes; and have a much higher in-frame dynamic range.

Each pixel in an event-based vision sensor is effectively a change detector, signalling a change event if the generated photocurrent of the pixel changes by more than a set percentage from the level at which it last emitted a change event. An ON event signals an increase of the photocurrent, while an OFF event signals a decrease in photocurrent. These two types of event have a separate parameter that controls the percentage change required to emit an event. These are set as global parameters for the sensor by the control software. In addition, some models of event-based vision sensor perform pixel exposure measurements, each of which is triggered by any change detection event.

The output of an event-based vision sensor can be expressed as a multi-column stream of numbers, which represent the pixel location, event polarity (increase or decrease in brightness), time, and exposure measurement information (for models that perform exposure measurements).

The system and method disclosed herein facilitate the production and analysis of high-temporal resolution RSO brightness data, known as ‘lightcurves’, as well as high temporal resolution event-rate plots, both of which leverage the aforementioned advantages of event-based vision sensors to better perform characterisation tasks such as those mentioned in paragraph above.

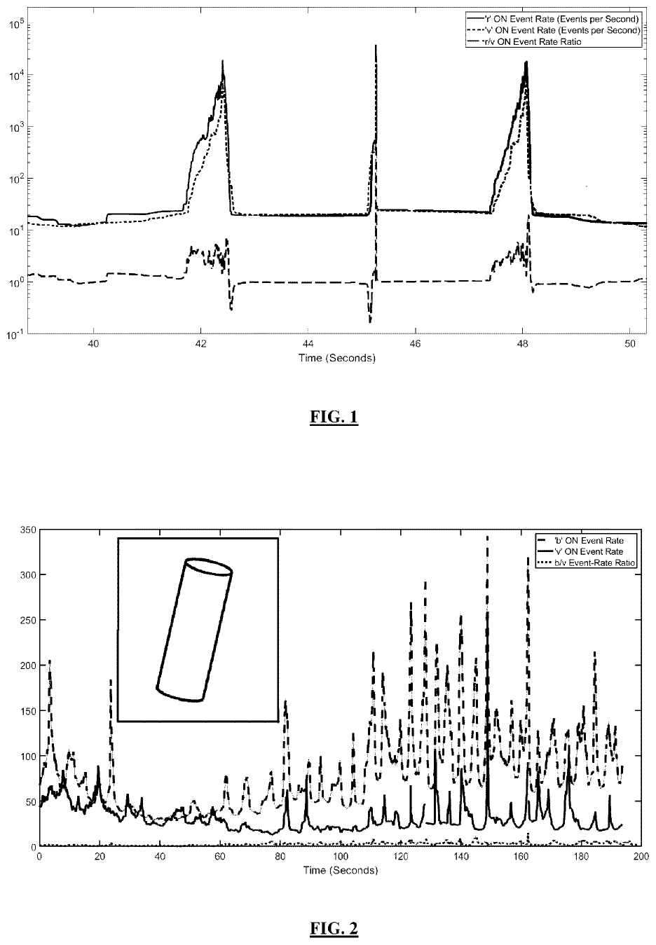

The plots shown in FIGS. 1-4 were obtained from event signals from an event-based vision sensor, specifically a Generation 4 event-based camera manufactured by Prophesee. In each case, one or more event-based sensor was mounted to an optical telescope directed toward a specific object in the form of the respective RSO (i.e., LEO satellite Globalstar 06, rocket body or LEO satellite Globalstar 22), with the telescope, and thereby the event-based sensor(s), being configured to track the RSO.

The high temporal resolution of event-based sensors results in more information being able to be derived from event-rate plots such as those shown in the accompanying Figures than is possible from lightcurves produced using frame-based sensors. All satellites are different, however, and therefore there is no single optimal procedure for analysing event-rate curves for all satellites. For example, for geosynchronous RSOs or rotating RSOs in LEO, the timing of event-rate spikes can be used to calculate the angular width of bright specular reflections. To achieve this, the satellite rotation period needs to be calculated by identifying event-rate features that correspond to the same satellite surface on consecutive rotations and measuring the time between them. The temporal length of an event-rate spike can then be measured and divided by the satellite rotation period. Multiplying that result by 360 gives the angular width of the specular reflection that caused the event-rate spike, in degrees. Not all satellites or satellite passes over an observer will exhibit event-rate spikes that are suitable for that analysis.

When two cameras are used simultaneously, with different colour filters fitted to each, simultaneous multicolour event-rate curves can be produced for a given object. By dividing one colour event-rate by the other colour event-rate, it is possible to see how the relative brightness in one colour changes relative to the brightness in the other colour. Commonly, during a specular reflection, the apparent colour of a material changes compared to when the diffuse reflection is observed. The colour change is different from one material to another, providing a means of differentiating between some materials.

FIG. 1 shows a plot of 12 seconds of event-rate data for the tumbling LEO satellite Globalstar 06. There are three event-rate spikes due to bright reflections off different surfaces. The central spike is considerably narrower than the other two spikes, characteristic of a more specularly reflecting surface. The central red/green (r/v) event-rate ratio spike is also narrower and of greater magnitude (redder) than the other two. The characteristics of the central spike are consistent with a smooth, flat aluminium surface or a solar panel, whereas the characteristics of the other two spikes are consistent with an uneven specular surface such as multi-layer insulation.

The aforementioned specular reflection width and colour data can be compared to a library of spacecraft materials to classify the type of material responsible for bright reflections. For unknown objects, including debris, surface material information can help to understand the origin of the object or its drag coefficient, which can potentially increase the accuracy of orbit propagation. For tumbling satellites of known construction, surface material information can aid the determination of the satellite's rotation axis by constraining the possible range of orientations during each specular reflection. The high temporal resolution of the event-rate data also results in much finer detail than is usually available in frame-based sensor lightcurves. The additional detail reduces ambiguity regarding RSO rotation rates when opposite sides of an RSO have very similar brightness characteristics.

In some cases, satellite axis of rotation can be inferred simply from the presence or absence of event-rate spikes. For example, in the event-rate plot shown in FIG. 2, which is for a tumbling rocket body, there are sharp event-rate spikes every half-rotation as the side of the rocket body reflects towards the observer. However, between approximately 25 and 60 seconds after the start of the recording, there are no event-rate spikes because the axis of rotation points towards the sensor, resulting in a relatively unchanging reflection towards the sensor. One example of the importance of understanding satellite rotation state is when a second satellite is used to attach to the first satellite for servicing or to remove it from orbit. Misidentifying the satellite rotation state could result in destruction of both satellites, or at least failure of the mission.

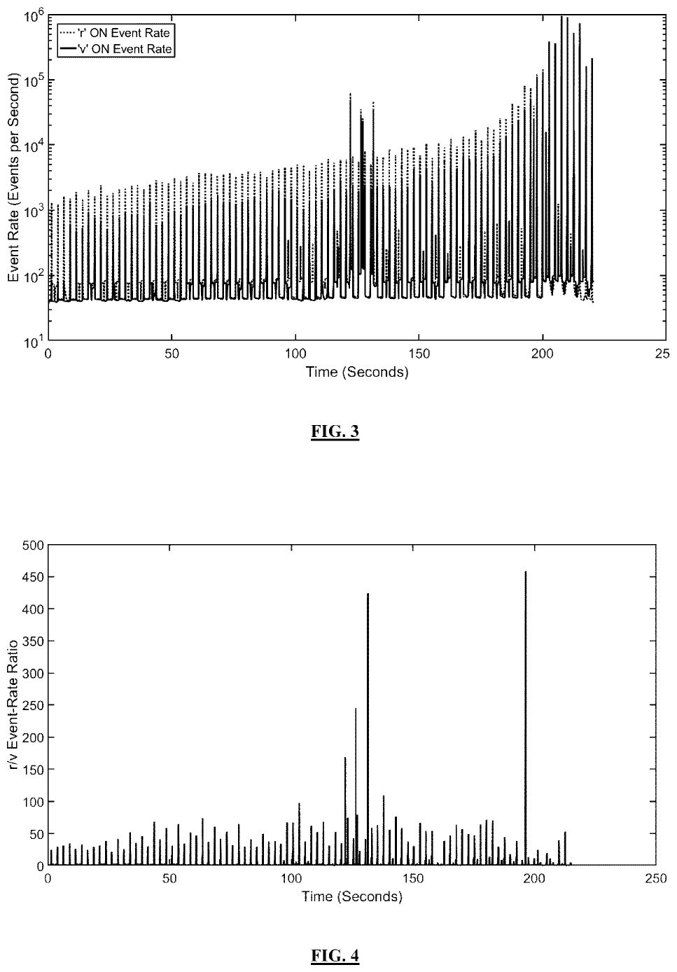

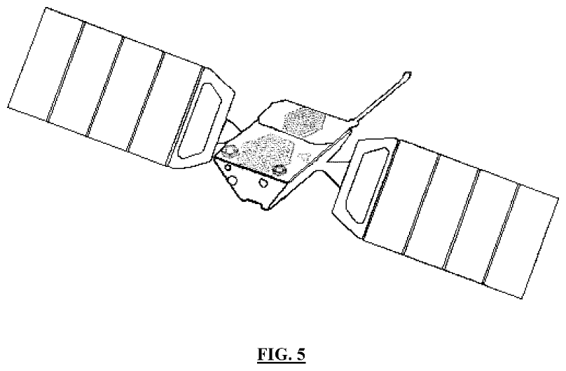

FIGS. 3 and 4 depict a colour event-rate plot and a plot of event-rate ratios of the tumbling LEO Globalstar 22. FIGS. 3 and 4 provide a further example of how these data can be used to infer satellite orientation and rotation information. First, from the periodic nature of the plots, it can be seen that the satellite's apparent rotation period is 4.97 seconds. Examining the image of the satellite, which is shown in FIG. 5, and analysing the timing, width and amplitude of the various event-rate spikes and event-rate ratio spikes, it can be shown that the four prominent spikes at about 130 seconds are due to reflections off the two solar panels. Further, because of the separation in time of the solar panel spikes, it can be shown that the solar panels are oriented with a 48 degree angle of separation. Because the mirror-like solar panels need to be oriented quite precisely to reflect light towards the sensor, they cause only very few event-rate spikes. The timing of those spikes, combined with knowledge of the satellite's location relative to the sensor, and the position of the sun, therefore indicates the orientation of the solar panels at the time of the event-rate spikes. The majority of the other spikes are consistent with reflections off the gold-coloured multi-layer insulation seen on the ends of the satellite body. The bottom side of the satellite body has a shiny, flat metal surface, which also requires precise orientation to reflect brightly towards the sensor. The narrow event-rate spike at 196 seconds, with associated prominent event-rate ratio spike, is consistent with that satellite surface. Further analysis can yield more information, however this example serves to illustrate how the plots of event-rate and event-rate ratio can be used to characterise RSOs.

Variations in the event rate and/or brightness data over time may be logged relative to GPS time to allow this data to be combined with other data, such as satellite orbital data or data from additional event-based sensors, at a later time, for further analysis.

For the examples described with reference to FIGS. 1-5, the event rate was determined according to the following method:
a. Deeming that multiple event signals generated: (i) along a linear path across the pixel array of the sensor; and (ii) in close proximity to one another, are associated with a RSO. In this regard, close proximity means the multiple event signals being generated within a predetermined time interval of one another, such as in the order of within one millisecond of one another.
b. Determining the centre and/or velocity of the RSO from one or more of the multiple event signals, such as by assigning the centre of the RSO to be the location of the pixel of the sensor that was associated with the last of the multiple event signals.
c. Deeming that subsequent event signals are associated with the RSO using the method described in paragraph below.
d. Determining, for each pixel associated with those event signals deemed to be associated with the RSO, the time interval between each of those event signals associated with that pixel.
e. Determining a moving mean of those time intervals for a predetermined number of the event signals. Typically, the predetermined number of events is approximately one tenth of the number of event signals generated per second that are deemed to be associated with the RSO.
f. Determining the event rate at the time of each of those event signals to be the inverse of the moving mean at that time.

In relation to step (d) above, if, for example, the RSO occupies two pixels (A and B), and pixel A generates a first event signal at a first point in time and a second event signal 100 milliseconds later, and pixel B generates a first event signal at a first point in time and a second event signal 100 milliseconds later, with the event signals of pixel A and pixel B being offset from one another temporally by one millisecond, then two time intervals, each of 100 milliseconds are determined (not two time intervals of one millisecond and two time intervals of 99 milliseconds).

Event signals output from the sensor were deemed to be associated with the RSO based on whether:
(i) the event signal was generated within a first predetermined distance from the centre of the RSO at that point in time; and/or
(ii) the event signal was generated: (a) along a trajectory of the RSO across the pixel array of the sensor; and/or (b) in close proximity to a most recent earlier said event signal associated with the RSO.

In this regard, close proximity means: the event signal being generated within a first predetermined time interval from the most recent earlier said event signal associated with the RSO; or the event signal being generated within a second predetermined distance from the centre of the specific object, wherein the second predetermined distance may be the same as or different to the first predetermined distance. The first predetermined distance may be based on the number of pixels of the event-based vision sensor occupied by the RSO and may be approximately equal to the diameter of a circle of pixels of the sensor occupied by the RSO.

Regardless of the method used for associating event signals with the respective RSO, the centre and velocity of the RSO were updated based on the location and timing of subsequent event signals that are associated with the RSO. The centre of the RSO was recalculated periodically based on subsequent said event signals that are associated with the RSO and a velocity of the RSO across a pixel array was calculated from changes in the location of the centre over time. The centre of the specific object was re-determined approximately every 10 milliseconds.

For the examples described with reference to FIGS. 1-5 in which brightness of the RSO was determined, the brightness was determined based on exposure measurements corresponding with the event signals deemed as being associated with the RSO. Determining the brightness of the RSO from the exposure measurements comprised summing all associated said exposure measurements within a predetermined distance from the centre of the RSO. Again, this predetermined distance may be based on the number of pixels of the event-based vision sensor occupied by the RSO and may be approximately equal to the diameter of a circle of pixels of the sensor occupied by the RSO.

As described above, the method facilitates inferring or determining information about an RSO based on variations in the event rate and/or brightness over time. The inferring or determining information based on variations in the rate and/or brightness over time may comprise identifying repeating patterns in the rate and/or brightness over time and determining a rotational speed of the specific object about one or more axes based on a frequency at which those patterns repeat. The method may comprise calculating the temporal length of a spike in the rate and/or brightness to determine an angular width of a specular reflection that caused that spike.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of such variations and/or modifications include, but are not limited to:
The event signals output from the sensor being associated with the respective RSO based on whether the event signals occur along a trajectory of the RSO and/or in close proximity to the most recent earlier event signal associated with the RSO. In this regard, close proximity may be measured in terms of the time between the event signals or a distance between the event signal and the centre of the RSO.
Determining the event rate by calculating the number of event signals deemed as being associated with an RSO that are generated in sequential time intervals each of a predetermined duration. The predetermined duration may be approximately one tenth of a second.
Location information associated with said event signals being adjusted to account for changes in the orientation of the sensor, thereby to permit event rate and brightness data to be acquired for multiple RSOs simultaneously.
The event signals output from the sensor being associated with the respective RSO based on whether the event signals occur within a subframe of the pixel array that is visually determined to contain the RSO.

1. A method for remote monitoring, comprising:
determining, from event signals obtained from an event-based vision sensor, a rate of the event signals generated in response to changes associated with a specific object; and
determining a brightness of the specific object from exposure measurements associated with the event signals.

2. The method of claim 1, wherein the specific object is located in a region remote from the sensor, and the sensor is configured to generate event signals, in response to changes it senses in the remote region.

3. The method of claim 2, wherein:
the sensor is located on Earth or on a resident space object (RSO), and the remote region is in space; or
the sensor is located in space and the remote region is located on Earth.

4. The method of claim 1, wherein the specific object is a RSO, a drone, a missile, an animal, or a structure.

5. The method of claim 1, comprising:
logging variations in the rate and/or the brightness over time; and
inferring or determining information about the specific object based on the variations in the rate and/or brightness over time.

6. The method of claim 5, wherein the inferring or determining information based on variations in the rate and/or brightness over time comprises identifying repeating patterns in the rate and/or brightness over time and determining a rotational speed of the specific object about one or more axes based on a frequency at which those patterns repeat.

7. The method of claim 1, comprising calculating a temporal length of a spike in the rate and/or brightness to determine an angular width of a specular reflection that caused that spike.

8. The method of claim 1, comprising determining, from event signals obtained contemporaneously from two event-based vision sensors, each of the event-based vision sensors having a different color filter, a rate of those event signals generated in response to changes associated with a specific object.

9. The method of claim 8, comprising determining material characteristics of the specific object based on differences in the event rate data and/or brightness data from each of the sensors.

10. The method of claim 1, comprising associating a said event signal with a specific object based on:
(i) the event signal being generated in response to a said change occurring within a first predetermined distance from a center of the specific object; and/or
(ii) the event signal being generated in response to a said change occurring: (a) along a trajectory of the specific object; and/or (b) in close proximity to a most recent earlier said event signal associated with the specific object; and/or
(iii) whether the event signals occur within a subframe of a pixel array of the sensor that is visually determined to contain the specific object.

11. The method of claim 10, wherein the associated said change occurring in close proximity to the most recent earlier said event signal comprises: the associated said change occurring within a first predetermined time interval; and/or the associated said change occurring within the first predetermined distance from the center of the specific object.

12. The method of claim 1, comprising re-determining a center of the specific object periodically based on subsequent said event signals that are associated with the specific object.

13. The method of claim 1, wherein said determining the rate of those event signals generated in response to changes associated with the specific object comprises:
determining, for each pixel associated with those event signals, the time interval between each of those event signals associated with that pixel;
determining a moving mean of those time intervals for a predetermined number of event signals; and
determining the rate at the time of each of those event signals to be the inverse of the moving mean at that time.

14. The method of claim 13, wherein the predetermined number of events is approximately one tenth of the number of those event signals generated per second.

15. The method of claim 1, wherein said determining the brightness of the specific object from the exposure measurements comprises summing all associated said exposure measurements within a predetermined distance from the a center of the specific object.

16. The method of claim 1, comprising adjusting an orientation of the sensor based on a trajectory of a said specific object.

17. The method of claim 16, comprising adjusting location information associated with said event signals to account for changes in the orientation of the sensor.

18. The method of claim 1, comprising logging variations in the rate relative to GPS time.

19. The method of claim 1, comprising inferring or determining information about the specific object based on variations over time in the rate together with: (i) information on the specific object obtained from sources other than the or each said sensor; and/or (ii) information on the specific object obtained from the or each said sensor on a different date or at a different time.

20. The method of claim 19, wherein said information on the specific object obtained from sources other than the or each said sensor comprises orbital data and/or data from other sensors.
